(19) United States
(12) Patent Application Publication
(10) Pub. No.: US 2018/0011933 A1
(43) Pub. Date: Jan. 11, 2018

(54) METHOD, APPARATUS, AND SERVER FOR GENERATING HOTSPOT CONTENT

(71) Applicant: GUANGZHOU UCWEB COMPUTER TECHNOLOGY CO., LTD., Guangzhou (CN)

(72) Inventor: Huijuan CHEN, Guangzhou (CN)

(21) Appl. No.: 15/468,258

(22) Filed: Mar. 24, 2017

(30) Foreign Application Priority Data
Jul. 8, 2016 (CN) 201610540758.3

(51) Int. Cl. G06F 17/30; G06F 17/27; G06F 7/08

(52) U.S. Cl. CPC G06F 17/30864; G06F 17/30899; G06F 7/08; G06F 17/2705

(57) ABSTRACT

A method, an apparatus and a server for generating hotspot content are provided. The method for generating hotspot content includes: acquiring a first keyword based on data relating to usage of a browser by a user; acquiring a second keyword based on information content crawled from an external website; and generating hotspot content based on the first keyword and the second keyword.

### CROSS-REFERENCES TO RELATED APPLICATIONS

This application claims priority of Chinese Patent Application No. 201610540758.3, filed on Jul. 8, 2016, the entire contents of which are hereby incorporated by reference.

### FIELD OF THE DISCLOSURE

The present disclosure generally relates to the field of web browser technology and, more particularly, relates to a method, apparatus, and server for generating hotspot content.

### BACKGROUND

With the development of browser technology, content provided through a browser is increasingly diverse. A browser not only provides browsing capabilities, but also actively provides information to a user. Such information provided to the user may include the so-called “hotspot content”.

The user is able to have an improved user experience, when the hotspot content is actively provided. When the hotspot content of user's interest is accurately provided, user adhesiveness to the browser may be even improved. Accordingly, the usage rate of the browser is increased, which is of great significance to the browser provider.

However, how to improve the accuracy of the hotspot content has been a technical problem under constant focus by technical professionals. For example, what parameters should be adopted to improve the accuracy of the hotspot content? What kind of processing method can be used to improve the accuracy of the hotspot content?

Further, users from different countries and/or different regions often have different cultures, habits and needs. Therefore, there is a need to provide hotspot content according to different users.

The disclosed method, apparatus, and server are directed to solve one or more problems set forth above and other problems in the art.

### BRIEF SUMMARY OF THE DISCLOSURE

One aspect of the present disclosure provides a method for generating hotspot content comprising: acquiring a first keyword based on data relating to usage of a browser by a user; acquiring a second keyword based on Information content crawled from an external website; and generating hotspot content based on the first keyword and the second keyword.

Another aspect of the present disclosure provides an apparatus for generating hotspot content, comprising: a first device for acquiring a first keyword based on data relating to usage of a browser by a user; a second device for acquiring a second keyword based on information content crawled from an external website; and a third device for generating hotspot content based on the first keyword and the second keyword.

Another aspect of the present disclosure provides a server, comprising: a receiving device, for receiving data relating to usage of a browser by a user and information content crawled from an external website; and at least one processor, for acquiring a first keyword based on the data relating to the usage of the browser, acquiring a second keyword based on the information content crawled from the external website, and generating hotspot content based on the first keyword and the second keyword.

Other aspects and advantages of the present disclosure can be understood by those skilled in the art through the exemplary embodiments of the present disclosure further described in detail with reference to the accompanying drawings.

### BRIEF DESCRIPTION OF THE DRAWINGS

The accompanying drawings, which are incorporated in and constitute a part of the specification, illustrate embodiments of the present disclosure and, together with the description, serve to explain the principles of the present disclosure.

FIG. 1 illustrates a flowchart of an exemplary method for generating hotspot content consistent with disclosed embodiments;

FIG. 2 illustrates a block diagram of an exemplary server consistent with disclosed embodiments;

FIG. 3 illustrates a block diagram of another exemplary server consistent with disclosed embodiments;

FIG. 4 illustrates a schematic view of an exemplary hotspot content generating system consistent with disclosed embodiments;

FIG. 5 illustrates an exemplary method for generating hotspot content consistent with disclosed embodiments; and

FIG. 6 illustrates another exemplary method for generating hotspot content consistent with disclosed embodiments.

### DETAILED DESCRIPTION

Various exemplary embodiments of the present disclosure will now be described in detail with reference to the accompanying drawings. It should be noted that unless otherwise specifically stated, the relative arrangement of the components and steps, the numerical expressions and numerical values set forth in these embodiments do not limit the scope of the present invention.

The following description including at least one exemplary embodiment is merely for illustrative purposes and is not intended limit the applications or uses of present invention.

Techniques, methods and equipment known by one of ordinary skill in the relevant art may not be discussed in detail, but wherever appropriate, the techniques, methods and equipment should be considered as part of the specification.

In all the examples shown and discussed herein, any specific value is construed merely as illustrative, and not as a limitation. Thus, other examples of the exemplary embodiments may have different values.

It should be noted that similar reference numerals and letters denote similar items in the following figures, and thus once an item, is defined in one figure, it needs no further discussion in the subsequent figures.

The present disclosure is further described in detail below in conjunction with various embodiments with reference to the accompanying drawings.

A browser provider may provide the browser software to users. A user may install the browser on a client terminal. When the user uses the browser, the browser may send the user usage information to the browser provider's server. In addition, the server may crawl information from other websites. In one embodiment of the present disclosure, the data collected within the browser and data crawled from the external website may be combined, such that the accuracy of hotspot content provided to the user may be improved.

In various embodiments, the browser may be an individual application program, such as IE browser, Chrome browser, or the like, or may refer to an application program integrated with browser functions, such as Facebook application, WeChat application, or the like. The browser may be used in desktop computers, notebook computers, tablet computers, mobile phones, smart watches, and/or other suitable electronic devices.

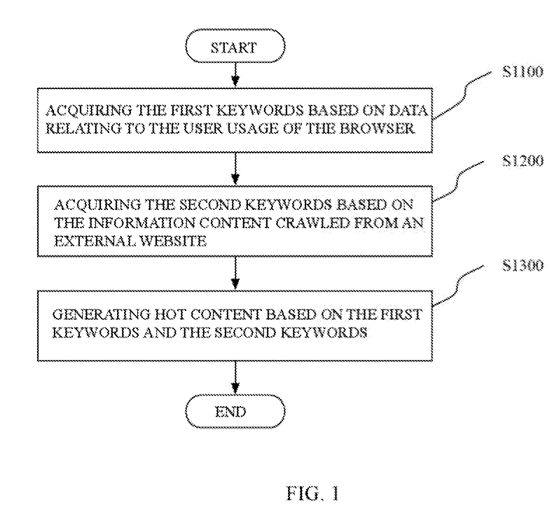

FIG. 1 illustrates a flowchart of an exemplary method for generating hotspot content consistent with disclosed embodiments.

As shown in FIG. 1, in step S1100, the first keywords may be acquired based on the data relating to the user usage of the browser. The user usage of the browser may include, for example, searching in the browser, browsing webpages, inputting user comments, etc.

In one embodiment, the user may use the browser to search webpages. For example, the user may use a browser to open a search webpage, such as a search engine, and enter a search term. In this case, the first keywords may be acquired based on the search term entered by the user in the search webpage. The search term and/or the associated words may be used as the first keywords. For example, the user may search in the search engine using a search term such as music, MP3, singer, entertainment, etc. The browser may record the user's search term. The search term may be used as the first keywords.

In another embodiment, the first keywords may be acquired by acquiring the browsed content in the webpage viewed by the user, and semantically parsing the browsed content. For example, the user may browse news about movies. To acquire the first keyword, the content of the news may be semantically parsed. The pared content may include, for example, movie, a movie name, entertainment, a movie leading character name, etc.

In step S1200, the second keywords may be acquired based on the information content crawled from an external website. An external site may refer to a website other than the websites that are browsed by the browser. The external website may be run by the browser provider or may be run by other content providers. For example, an external website of a web portal may be Sina, Sohu, Tencent, Facebook, Yahoo or any other suitable informative websites. The informative website may provide hotspot content in various forms. In disclosed embodiments, information content may be crawled from the informative websites to acquire the second keywords.

The second keywords may be acquired from the information content in a plurality of ways. In one embodiment, acquiring the second keywords may include semantically parsing the crawled information content to acquire the second keywords. The present disclosure may include any suitable methods for semantic parsing. For example, some words acquired by semantically parsing the information content may be selected as the second keywords. In one embodiment, only the words in the title of the information content may be selected as the second keywords. In another embodiment, words having a substantially high repetition rate in the information content, excluding function words such as “of”, “and”, etc., may be selected as the second keywords. The second keywords may be selected from the words acquired by semantically parsing the information content according to various application scenarios.

Users in different countries and/or different regions may have different cultures, habits, needs, languages, etc. The technical solutions provided by the present disclosure may be beyond simply and statically configuring the websites to have information content crawled therefrom. International communications become more and more frequent, more and more convenient. Accordingly, the browser may be provided to users in different countries and/or different regions. Therefore, it may be desired to make the improvements to meet the needs of users in different countries and/or different regions.

In one embodiment, the external website to crawl the information content therefrom may be determined. For example, acquiring the second keywords may include determining an external website to crawl based on user attributes. In one embodiment, the websites to crawl may be determined based on a plurality of user attributes. The user attributes may include at least one of applications in client terminal of the user, the user location, and/or any other suitable user attributes.

For example, an application program used in the client terminal of the user, such as an APP used in the client terminal of the user, may be Weibo, Facebook, VK, WeChat, etc. Information content may be acquired from these websites corresponding to the application programs and thus to acquire the second keywords.

The user location may be country and region where the user is located, etc. For example, a user location may be in India. The user may want to know more information about India. According to the user location, the external website to crawl may be determined to be, for example, Facebook social website or any other suitable website, which is popular in India. For example, Facebook trending charts may be selected for semantic parsing. The second key word may be acquired by semantically parsing the content information (such as a hotspot topic). For example, the websites Sina and Sohu may be websites which Chinese users often visit. When the detected user location is in China, the second keywords may be acquired by semantically parsing the content information from the exemplary websites of Sina and Sohu.

As such, by the use of user attributes to determine the external websites to crawl, the accuracy of hotspot content provided and recommended to the user may be improved.

In the step S1300, based on the first keywords and the second keywords, hotspot content may be generated.

Based on the first keywords and the second keywords, a plurality of ways may be adopted to generate hotspot content. For example, the keywords may be used directly for search to acquire the hotspot content.

In one embodiment, generating hotspot content based on the first keywords and the second keywords may include sorting the first keywords and the second keywords according to the click volumes or click rate. Based on the sorting result, the keywords with a higher click volume may be selected. Accordingly, hotspot content may be generated based on the selected keywords, for example, by searching for relevant information based on the selected keywords.

Further, the keywords may be modified. In certain scenarios, different keywords may correspond to a same content. For example, both “movie” and the movie name “World of Warcraft” may indicate the user's interest in the movie “World of Warcraft”. Combining these two keywords may better represent the user's actual intention. Thus, in one embodiment, generating hotspot content based on the first and second key words may also include reverse semantic parsing of the first and second keywords to acquire one or more third keywords. Through the reverse semantic parsing, some keywords may be combined, such that the user's possible intention may be represented with increased accuracy. Accordingly, the accuracy of keyword recommendation may be improved. The third keywords may be sorted based on the click volumes of the first keywords and the second keywords. Next, hotspot content may be generated based on the sorted third keywords.

In disclosed embodiments, through the use of internally generated data in the browser and data crawled from the external websites, hotspot content may be generated and the accuracy of generated hotspot content may be improved.

Further, in one embodiment, the external websites to crawl may be determined based on user attributes, such that the accuracy of generated hotspot content may be further improved. For example, personalized hotspot content may be provided for individual users. In addition, this approach may also meet the different needs of users in different countries and/or different regions.

In addition, in one embodiment, after acquiring the first keywords and the second keywords, through reverse semantic parsing of the keywords, the accuracy of the recommended keywords may be further improved.

In various embodiments, the disclosed methods may be implemented by various products including software, hardware, and the combination, of software and hardware. For example, various embodiments may include an apparatus for generating hotspot content. An exemplary apparatus may include a first device for acquiring the first keywords based on data relating to user usage of a browser, a second device for acquiring the second keywords based on information content crawled from an external website, and a third device for generating hotspot content based on the first keywords, the second keywords, and/or the third keywords.

For example, the first device for acquiring the first keywords may include a device for acquiring the first keywords based on a search term entered by the user in the search pages.

For example, the device for acquiring the first keywords may include a device for acquiring browsed content in the browsed webpage, and a device for acquiring the first keywords by semantically parsing the browsed content.

For example, the device for acquiring the second keywords may include a device for acquiring the second keywords by semantically parsing the crawled information content.

For example, the device for acquiring the second keywords may include a device for determining the external websites to crawl based on user attributes.

For example, the user attributes may include at least one of applications in client terminal of the user, the user location and/or any other suitable user attributes.

For example, the device for generating hotspot content based on the first keywords and the second keywords may include a device tor sorting the first keywords and the second keywords according to the click volumes.

For example, the device for generating hotspot content based on the first keywords and the second keywords may include a device for performing reverse semantic parsing of the first and second keywords to acquire the third keywords.

For example, the device for generating hotspot content based on the first keywords and the second keywords may include a device for sorting the third keywords based on the click volumes of the first keywords and the second keywords, and a device for generating hotspot content based on the sorted third keywords.

Those skilled in the art would understand that as technology develops, the boundaries between the server and the client terminal are becoming increasingly blurred. Thus, the disclosed technical solutions may be implemented on the client terminal, and may also be implemented on the server side, or the various functions of the technical solutions may be distributed on at least one of different servers and different client terminals, all of which are readily apparent to those skilled in the art.

The apparatus for generating hotspot content may be a standalone device (e.g. on a separate rack), or may be integrated in a server, i.e. as part of the server. Accordingly, the server may be used to generate hotspot content and delivery the hotspot content to the client terminal. Thus, technical solutions of the present disclosure may be implemented in the server to generate hotspot content.

In addition, with the development of electronic information technology such as huge scale integrated circuit technology and the trend that software functions are implemented by hardware, clearly distinguishing the boundary between hardware and software of the computer system may be substantially difficult. Operations disclosed herein may be implemented by hardware, and may also be implemented by software. The execution of instructions may be completed by hardware, such as one or more processors, and may also be completed by software, or their combinations. Whether to use hardware, software, and/or their combination to realize the machine function may depend on price, speed, reliability, storage capacity, change cycle and other non-technical factors. The implementations of the technical solution may be described to clearly illustrate the technical solution in the disclosed embodiments. Based on the disclosed embodiments, persons of ordinary skill in the art may derive other embodiments consistent with the present disclosure, all of which are within the scope of the present invention. Thus, in one embodiment, a server may be provided, which is designed for implementing following exemplary operations; acquiring first keywords based on data relating to the user usage of the browser; acquiring the second keywords based on information content crawled from the external website; and generating the hotspot content based on the first keywords and the second keywords.

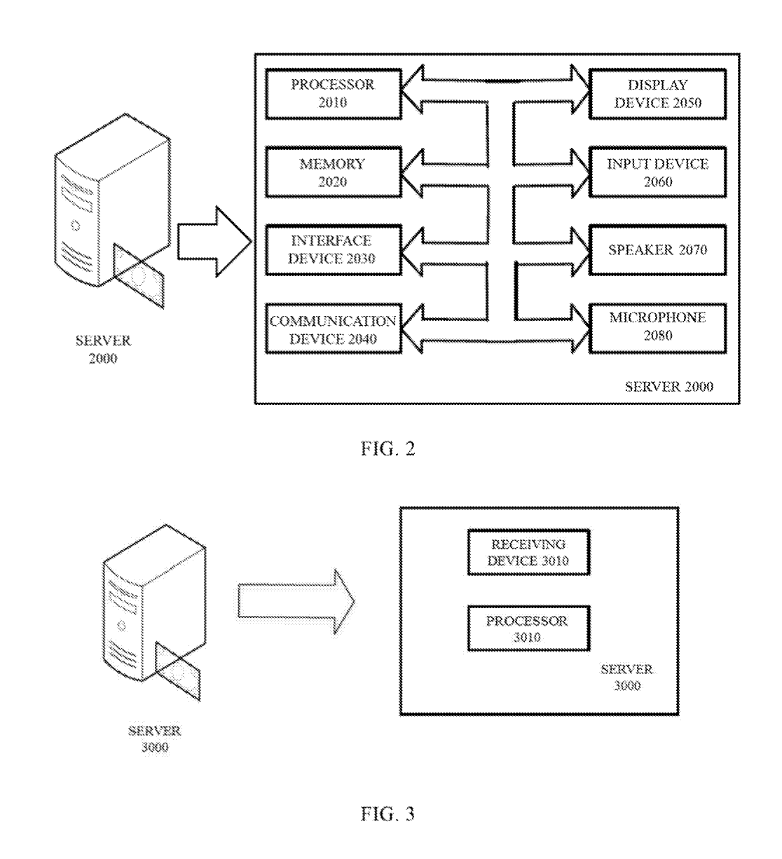

FIG. 2 illustrates a block diagram of an exemplary server consistent with disclosed embodiments. As shown in FIG. 2, the server 2000 may include a processor 2010, a memory 2020, an interface device 2030, a communication device 2040, a display device 2050, an input device 2060, a speaker 2070, and a microphone 2080.

The processor 2010 may be a central processing unit (CPU), a microprocessor (MCU), etc. The memory 2020 may include a read only memory (ROM), a random access memory (RAM), and a nonvolatile memory such as a hard disk, etc. The interface device 2030 may include a universal serial bus (USB) port, a headphone jack, etc.

The communication device 2040 may be able to perform wired or wireless communications.

The display device 2050 may be a liquid crystal display panel, a touch screen display panel, etc. The input device 2060 may include a touch screen, a keyboard, etc. A user may input a voice message through the speaker 2070 and may output a voice message through the microphone 2080.

The devices shown in FIG. 2 are for illustrative purposes and are not intended to limit the disclosure, the applications or uses of present invention.

In one embodiment, the memory 2020 may be used to store instructions for controlling the processor 2010 to carry out operations, such that the method, shown in FIG. 1 for generating hotspot content may be executed. Those skilled in the art would understand that although a plurality of devices are shown in FIG. 2, the present disclosure may involve some or all of the devices. For example, the server 2000 in FIG. 2 may include the processor 2010 and the memory 2020 to implement the disclosed methods. Based on the present disclosure, those skilled in the art would be able to design instructions. The instructions may be stored on the memory and may be executed by one or more processors to implement the disclosed methods.

FIG. 3 illustrates a block diagram of another exemplary server consistent with disclosed embodiments.

As shown in FIG. 3, the server 3000 may include a receiving device 3010 and at least one processor 3020.

The receiving device 3010 may be used for receiving data relating to the usage of the browser by a user and information content crawled from an external website.

The processor 3020 may be used for acquiring the first keywords based on data relating to the usage of the browser by a user, acquiring the second keywords based on information content crawled from an external website, and generating hotspot content based on the first and second keywords.

The server shown in FIG. 3 is for illustrative purposes and in no way intended to limit the disclosure, the applications or uses of present invention.

In addition, those skilled in the art would understand that with the technology development, the boundaries between dedicated servers and electronic devices such as computers and laptops are becoming increasingly blurred. Thus, the server described herein may refer to an electronic device that functions as a server, for example, a dedicated server on a network, or a terminal device capable of executing a server function, such as a personal computer, a notebook computer, etc.

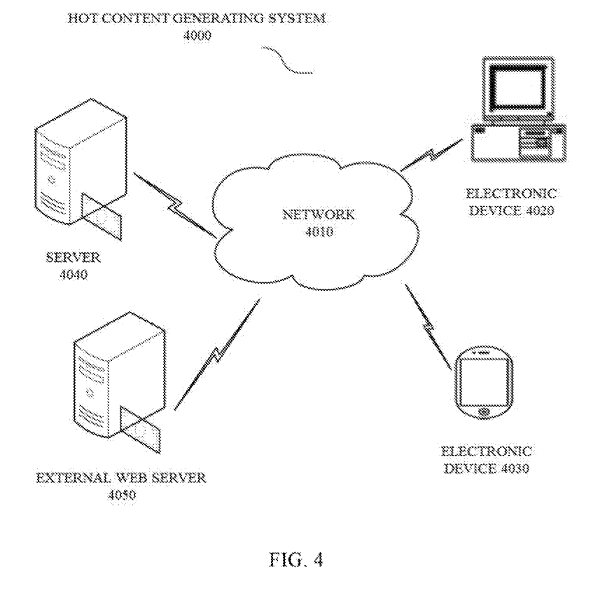

FIG. 4 illustrates a schematic view of an exemplary hotspot content generating system 4000 consistent with disclosed embodiments.

As shown in FIG. 4, a server 4040 may be used for providing hotspot content. The server 4040 may be connected to a first client electronic device 4020 and a second client electronic device 4030 through a network 4010. The server 4040 may also be connected to an external web server 4050 through the network 4010.

The server 4040 may acquire data relating to the user usage of the browser from the client electronic devices 4020 and 4030. For example, the browser in each of the electronic devices 4020 and 4030 may acquire user usage data and pass the data to the server 4040. The server 4040 may also crawl information content from the external web server 4050. The server 4040 may generate hotspot content based on the acquired user usage data and information content. Subsequently, the server 4040 may send the generated hotspot content to the electronic devices 4020 and 4030, respectively.

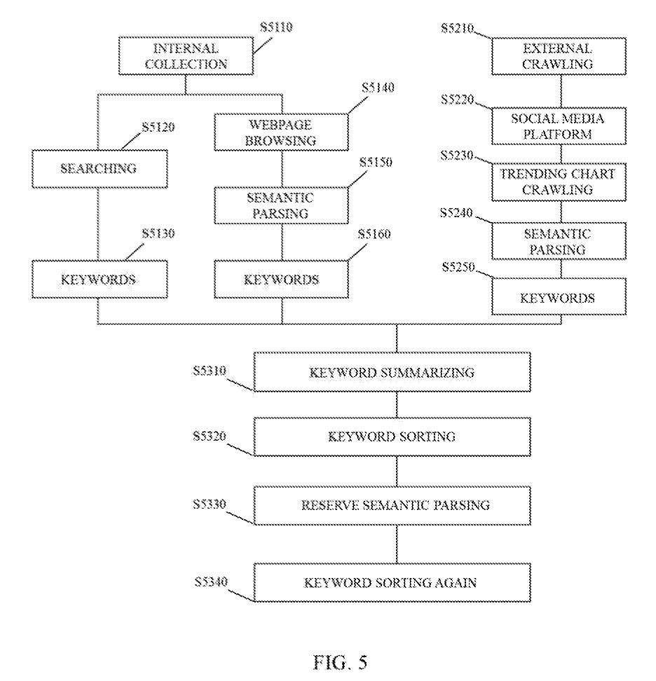

FIG. 5 illustrates an exemplary method for generating hotspot content consistent with disclosed embodiments.

As shown in the left side of FIG. 5, in step S5110, data relating to the user usage of the browser may be acquired through internal collection (i.e., via the browser). On the one hand, in step S5120, the browser may acquire the data generated by the user for the search operation, such as the key words used by the user. On the other hand, in step S5140, the browser may record the user's webpage data, such as the article viewed, the title of the article, etc. In step S5150 and step 5160, through the semantic parsing and decomposition of webpage data, keywords may be acquired. The first keywords may be acquired based on the keywords acquired through internal collection.

As shown in the right side in FIG. 5, in step S5210, the second keywords may be acquired by crawling external websites. For example, the social media platform (i.e. external website) to crawl may be determined based on user attributes. The user attributes may include at least one of APP in the client terminal of the user and user location, etc. Then, the hotspot information data may be crawled from the trending charts of the social media platform. In step S5240, the second keywords may be acquired through the semantic parsing and decomposition of hotspot information data.

Next, in step S5310 and S5320, the acquired first keywords and second keywords maybe summarized and subsequently sorted according to the click volumes.

In addition, in the disclosed embodiments, in step S5330, certain key words may also be combined through reverse semantic parsing of the keywords. Accordingly, the accuracy of the recommended hotspot content may be improved.

According to combined result, in step S5340, keywords may be sorted according to click volumes. Subsequently, hotspot content may be generated based on the sorted keywords, e.g. searching for hotspot content based on the keywords.

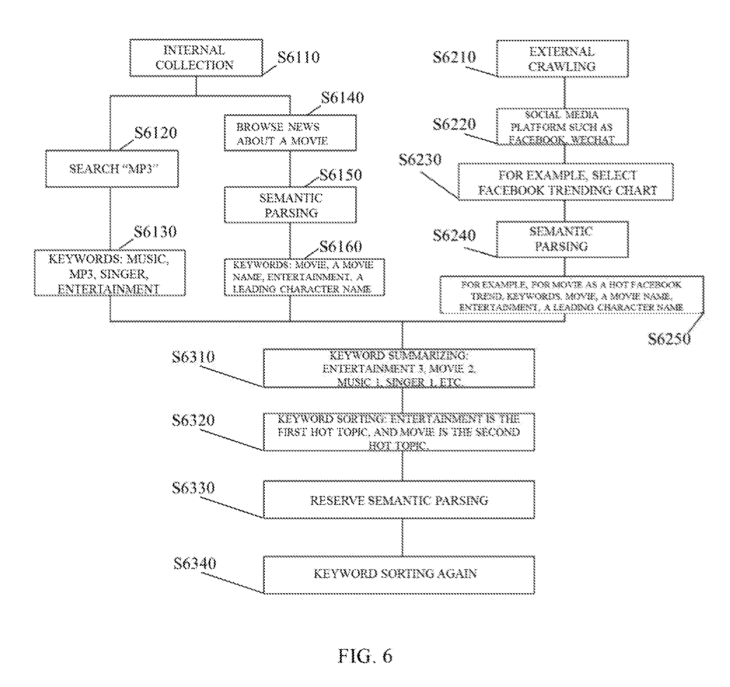

FIG. 6 illustrates another exemplary method for generating hotspot content consistent with disclosed embodiments.

As shown in FIG. 6, in the internal collection process, the browser may record a search term “MP3” used by the user in a search engine as shown in step S6120. Keywords corresponding to MP3 may be music, MP3, singer, entertainment, etc.

In addition, in step S6140, the user may also browse news about a movie. Keywords may be acquired through semantic parsing of the data relating to the news. The keywords may be movie, “World of Warcraft”, entertainment, a movie leading character name, etc.

In the process of crawling the external website as in step S6210, the external website may be determined first. For example, a social media platform may be crawled. WeChat website may be crawled for Chinese users. Facebook website may be crawled for American and Indian users. In one embodiment, Facebook trending charts may be objects to crawl. According to the classification of the charts, the crawled information content may be semantically parsed to acquire hotspot content. For example, the movie “World of Warcraft” may be heavily commented on Facebook. Accordingly, keywords may be decomposed into: movie, “World of Warcraft”, entertainment, a movie leading character name, etc.

Next, in step S6310, the acquired hotspot keywords may be summarized, for example, entertainment 3, movie 2, music 1, singer 1, etc. where the numbers represent the click volumes (i.e. the amount of times the keyword appears). Then, the keywords may be sorted according to the click volumes. Accordingly, entertainment may be the first hotspot topic and movie may be the second hotspot topic. According to each keyword ranking, reverse semantic parsing may be applied to the keywords to combine keywords representing same content. For example, both “movie” and “World of Warcraft” may show interest in the “World of Warcraft” movie. Thus, the two keywords may be combined. In step S6340, the combined keyword may be sorted again according to the click volumes. The sorted combined key words may be used for generating the hotspot content.

The present disclosure may include the various technical solutions. Various embodiments of the present disclosure provide a method for generating hotspot content. The disclosed method may include: acquiring a first keyword based on data relating to usage of a browser by a user, acquiring a second keyword based on information content crawled from an external website, and generating hotspot content based on the first keyword and the second keyword.

According to the disclosed method, acquiring the first keyword may include: acquiring the first keyword based on a search term inputted by the user in a search webpage, and obtaining browsed content from webpages browsed by the user and acquiring the first keyword by semantically parsing the browsed content.

According to the disclosed method, acquiring the second keyword may include: acquiring the second keyword by semantically parsing of the information content crawled from the external website, and determining which external website to crawl the information content, based on user attributes which may include at least one of applications used in a client terminal of the user and user's location.

According to the disclosed method, generating hotspot content based on the first keyword and the second keyword may include: sorting the first keyword and the second keyword according to click volumes, performing reverse semantic parsing of the first keyword and second keyword to obtain a third keyword, sorting the third keyword based on the click volumes of the first keyword and the second keyword, and generating hotspot content based on the sorted third keyword.

Various embodiments of the present disclosure provide an apparatus for generating hotspot content. The apparatus may include a first device for acquiring a first keyword based on data relating to usage of a browser by a user, a second device for acquiring a second keyword based on information content crawled from an external website; and a third device for generating hotspot content based on the first keyword and the second keyword.

According to the disclosed apparatus, the first device for acquiring the first keyword may include the first device for obtaining the first keyword based on a search term inputted by the user in a search webpage, and for acquiring the browsed content of the webpage viewed by the user and acquiring the first keyword by semantically parsing the browsed content.

According to the disclosed apparatus, the second device for acquiring the second keyword may include the second device for acquiring the second keyword by semantically parsing the crawled information content, and for determining which external website to crawl the information content based on user attributes which may include at least one of the applications in the client terminal of the user and the user location.

According to the disclosed apparatus, the third device for generating hotspot content may include the third device for sorting the first keyword and the second keyword according to click volumes, for acquiring a third keyword through reverse semantic parsing of the first keyword and the second keyword, for sorting the third keyword based on the click volumes of the first key words and the second keywords; and for generating hotspot content based on the sorted third keyword.

Various embodiments of the present disclosure provide a server which includes the disclosed apparatus, for generating hotspot content and providing the hotspot content to the client terminal.

Various embodiments of the present disclosure provide a server. The server may be designed for executing the following operations; acquiring a first keyword based on data relating to usage of a browser by a user, acquiring a second keyword based on information content crawled from an external website; and generating hotspot content based on the first keyword and the second keyword.

Various embodiments of the present disclosure provide a server. The server may include a memory and a processor. According to the disclosed server, the memory may be used for storing instructions and the instructions may control, the processor to carry out operations according to the disclosed method.

Various embodiments of the present disclosure provide a server. The server may include a receiving device for receiving data relating to usage of a browser by a user and information content crawled from an external website, and at least one processor for acquiring a first keyword based on the data relating to the usage of the browser by the user, acquiring a second keyword based on the information content crawled from the external website, and generating hotspot content based on the first keyword and the second keyword.

According to the present disclosure, by combining data collected within the browser and data crawled from the external website, the accuracy of hotspot content provided to the user may be improved.

The present disclosure may include a system, a method, and/or a computer program product. The computer program product may include a computer readable storage medium (or media), such as a non-transitory computer readable storage medium, having computer readable program instructions thereon for causing a processor to carry out aspects of the present disclosure.

The computer readable storage medium may be a tangible device that is able to retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user×s computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. Those skilled in the art would understand that the implementations by hardware, software or the combination of hardware and software may be equivalent.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. The scope of the present disclosure is defined by the appended claims.

What is claimed is:

1. A method for generating hotspot content, comprising:
acquiring a first keyword based on data relating to usage of a browser by a user;
acquiring a second keyword based on information content crawled from an external website; and
generating hotspot content based on the first keyword and the second keyword.

2. The method according to claim 1, wherein acquiring the first keyword includes:
acquiring the first keyword based on a search term inputted by the user in a search page.

3. The method according to claim wherein acquiring the first keyword includes:
obtaining browsed content from webpages browsed by the user, and
acquiring the first keyword by semantically parsing the browsed content.

4. The method according to claim 1, wherein acquiring the second keyword includes:
acquiring the second keyword by semantically parsing of the information content crawled from the external website.

5. The method according to claim 1, wherein acquiring the second keyword includes:
determining which external website to crawl the information content, based on user attributes, the user attributes including at least one of applications used in a client terminal of the user and user's location.

6. The method according to claim 1, wherein generating the hotspot content based on the first keyword and the second keyword includes:
sorting the first keyword and the second keyword according to click volumes,
performing reverse semantic parsing of the first keyword and second keyword to obtain a third keyword,
sorting the third key word based on the click volumes of the first key word and the second keyword, and
generating the hotspot content based on the sorted third keyword.

7. The method according to claim 1, further including:
providing the hotspot content to a client terminal of the user.

8. An apparatus for generating hotspot content, comprising:
a first device for acquiring a first keyword based on data relating to usage of a browser by a user;
a second device for acquiring a second keyword based on information content crawled from an external website; and
a third device for generating hotspot content based on the first keyword and the second keyword.

9. The apparatus according to claim 8, wherein the first device is configured for:
acquiring the first keyword based on a search term inputted by the user in a search page.

10. The apparatus according to claim 8, wherein the first device is configured for:
obtaining browsed content from webpages browsed by the user, and
acquiring the first keyword by semantically parsing the browsed content.

11. The apparatus according to claim 8, wherein the second device is configured for:
acquiring the second keyword by semantically parsing of the information content crawled from the external website.

12. The apparatus according to claim 8, wherein the second device is configured for:
determining which external website to crawl the information content, based on user attributes, the user attributes including at least one of applications used in a client terminal of the user and user's location.

13. The apparatus according to claim 8, wherein the third device is configured for:
sorting the first keyword and the second keyword according to click volumes,
performing reverse semantic parsing of the first keyword and second keyword to obtain a third keyword,
sorting the third keyword based on the click volumes of the first keyword and the second keyword, and
generating the hotspot content based on the sorted third keyword.

14. A server, comprising:
a receiving device, for receiving data relating to usage of a browser by a user and information content crawled from an external website; and
at least one processor, for acquiring a first keyword based on the data relating to the usage of the browser, acquiring a second keyword based on the information content crawled from the external website, and generating hotspot content based on the first keyword and the second keyword.

15. The server according to claim 14, further comprising:
a memory, having instructions stored thereon, the instructions executed by the at least one processor.

16. The server according to claim 15, wherein:
the memory includes a non-transitory computer-readable storage medium having instructions stored thereon.

17. The server according to claim 14, wherein
the hotspot content is provided to a client terminal of the user.

18. The server according to claim 14, wherein the at least one processor is further configured for:
acquiring the second keyword by semantically parsing of the information content crawled from the external website.

19. The server according to claim 14, wherein the at least one processor is further configured for:
determining which external website to crawl the information content, based on user attributes, the user attributes including at least one of applications used in a client terminal of the user and user's location.

20. The server according to claim 14, wherein the at least one processor is further configured for:
sorting the first keyword and the second keyword according to click volumes,
performing reverse semantic parsing of the first keyword and second keyword to obtain a third keyword,
sorting the third keyword based on the click volumes of the first keyword and the second keyword, and
generating the hotspot content based on the sorted third keyword.
